(19) United States
(12) Patent Application Publication
(10) Pub. No.: US 2020/0028848 A1
(43) Pub. Date: Jan. 23, 2020

(54) SECURE ACCESS TO APPLICATION INSTANCES IN A MULTI-USER, MULTI-TENANT COMPUTING ENVIRONMENT

(71) Applicant: Nutanix, Inc., San Jose, CA (US)

(72) Inventors: Vinod GUPTA, Fremont, CA (US); Ranjan PARTHASARATHY, Milpitas, CA (US)

(73) Assignee: Nutanix, Inc., San Jose, CA (US)

(21) Appl. No.: 15/674,923

(22) Filed: Aug. 11, 2017

(51) Int. Cl. H04L 29/06; G06F 21/33; G06F 21/10

(52) U.S. Cl. CPC H04L 63/0884; H04L 67/34; G06F 21/105; G06F 21/335

(57) ABSTRACT

Systems and methods for computer security in computer clusters. Techniques provide secure user access to applications that run in shared resource computing environments. A method embodiment commences upon identifying an application digital certificate corresponding to a subject application. The subject application is stored for access by a reverse proxy authorization service that also runs in the shared computing environment. Individual user processes are uniquely identified by corresponding user credentials. The reverse proxy authorization service processes a request to access the subject application, whereupon a generated subject application instance specific to the requestor is installed. Installation includes authentication using the application digital certificate for the subject application and authorization using the requestor's credentials. A second request from a second user to access the same subject application uses the same application digital certificate combined with the second requestor's credentials. The reverse proxy authorization service generates scope-specific access tokens for each generated instance.

### FIELD

This disclosure relates to computer security in computer clusters, and more particularly to techniques for secure access to individual instances of applications in a multi-user, multi-tenant computing environment.

### BACKGROUND

Many modern computing systems include virtualized entities (VEs), such as virtual machines (VMs), to improve the utilization of computing resources. Such VMs can be characterized as software-based computing “machines” implemented in a full virtualization environment or hypervisor-assisted virtualization environment that emulates the underlying hardware resources (e.g., CPU, memory, etc.). For example, multiple VMs can operate on one physical machine (e.g., host computer) running a single host operating system, while the VMs run multiple applications on various respective guest operating systems.

Another type VE that is often used in modern computing systems is the executable container. An executable container is implemented using operating system virtualization or container virtualization. The executable containers implemented in container virtualization environments comprise groups of processes and/or resources (e.g., memory, CPU, disk, etc.) that are isolated from the host computer and other executable containers. Such executable containers directly interface with the kernel of a host operating system, portions of which are often included in the executable container.

Clusters in a distributed system might scale to hundreds of nodes or more that support several thousand or more autonomous VEs. As such, the topology and/or the storage I/O activity of the distributed system can be highly dynamic. Users (e.g., system administrators) of such large scale, highly dynamic distributed systems desire applications or “apps” (e.g., management tools) that facilitate managing and/or analyzing the highly dynamic distributed systems. In some environments, these applications can be implemented in or as VMs, and/or in or as web services, and/or in or as executable containers as a containerized applications (CAs). Containerized applications can be configured to implement a particular function or set of functions without reliance on a fully-configured hardware and/or software platform. For example, a CA might be defined to perform some simple operation over some given inputs and then produce an output in a predefined format. The CAs can also provide a certain level of secure isolation from other components in the distributed virtualization system. In some cases, the CAs might implement a web server within the executable container image to facilitate access to the CA as a web service or as a microservice.

The foregoing implementation possibilities for application services can facilitate flexible utilization in distributed computing systems. For example, one or more resource owners (e.g., data provider, service provider, enterprise, etc.) each implementing a respective large, multi-user (e.g., multi-tenant) cluster in a distributed virtualization system may desire to implement multiple application instances to provide distribution across the cluster as well as to provide isolation from other users (e.g., other tenants). In some cases, the resource owners further desire to access not only to internally developed applications, but also may desire access to access publicly available applications that are posted to a marketplace or other application repository by third-party developers. Such applications are loaded into and run from a shared node or service within a shared multi-node computing system rather than being loaded onto a user's personal, unshared device such as a smart phone or laptop.

Unfortunately, legacy techniques for securely accessing multiple application instances in shared computing systems can be inefficient. Specifically, when multiple instances of a given application are invoked by multiple users across a distributed system, legacy approaches use self-signed digital certificate for each user of each given application so as to authenticate and authorize accesses to the given application for use by each particular user. However, in large scale, highly dynamic distributed systems, the resources consumed during formation of such unique self-signed digital certificates for each user of each given application can be significant. Moreover, in large scale, highly dynamic distributed systems where multiple tenants are hosted in a single shared computing platform, tenants demand a high degree of security when authenticating applications. What is needed is a technological solution for efficiently providing a higher degree of security than is afforded by self-signed certificates alone while avoiding wasteful resource usage associated with generating individual digital certificates for each user of each given application.

Some of the approaches described in this background section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

The present disclosure provides a detailed description of techniques used in systems, methods, and in computer program products for efficient and secure access to application instances in a multi-user computing environment, which techniques advance the relevant technologies to address technological issues with legacy approaches. More specifically, the present disclosure provides a detailed description of techniques used in systems, methods, and in computer program products for providing authorized user access to instances of authenticated containerized applications. Certain embodiments are directed to technological solutions for implementing a reverse proxy authorization service to facilitate authorized access to user-specific instances of applications using user-specific user credentials and a single application digital certificate for all instances of the application in the computing environment.

The disclosed embodiments modify and improve over legacy approaches. In particular, the herein-disclosed techniques provide technical solutions that address the technical problems attendant to efficiently managing secure access to multiple instances of applications. Some embodiments disclosed herein use techniques to improve the functioning of multiple systems within the disclosed environments, and some embodiments advance peripheral technical fields as well. As one specific example, use of the disclosed techniques and devices within the shown environments as depicted in the figures provide advances in the technical field of hyperconverged computing platform management as well as advances in various technical fields related to massively parallel computing systems.

Further details of aspects, objectives, and advantages of the technological embodiments are described herein and in the drawings and claims.

### BRIEF DESCRIPTION OF THE DRAWINGS

The drawings described below are for illustration purposes only. The drawings are not intended to limit the scope of the present disclosure.

FIG. 1 illustrates a computing environment in which embodiments of the present disclosure can be implemented.

FIG. 2 depicts a secure application access technique as implemented in systems that facilitate authorized user access to instances of authenticated applications, according to an embodiment.

FIG. 3 presents a data flow that implements authorized user access to instances of authenticated applications, according to an embodiment.

FIG. 4 is a diagrammatic representation of data structures used in systems for authorized user access to instances of authenticated applications, according to an embodiment.

FIG. 5 is a diagrammatic representation of component-to-component interactions that initialize authorized user access to instances of authenticated applications, according to an embodiment.

FIG. 6 is an interaction diagram showing component-to-component interactions that facilitate authorized user access to instances of authenticated applications, according to an embodiment.

FIG. 7 presents a distributed virtualization environment in which embodiments of the present disclosure can be implemented.

FIG. 8 depicts system components as arrangements of computing modules that are interconnected so as to implement certain of the herein-disclosed embodiments.

FIG. 9A, FIG. 9B and FIG. 9C depict virtualized controller architectures comprising collections of interconnected components suitable for implementing embodiments of the present disclosure and/or for use in the herein-described environments.

### DETAILED DESCRIPTION

Embodiments in accordance with the present disclosure address the problem of efficiently managing secure access to multiple instances of applications. Some embodiments are directed to approaches for implementing a reverse proxy authorization service to facilitate authorized access to instances of applications using user credentials and a single application digital certificate for all instances of a containerized application. The accompanying figures and discussions herein present example environments, systems, methods, and computer program products for authorized user access to instances of authenticated applications.

### Overview

Disclosed herein are techniques for implementing a reverse proxy authorization service to facilitate authorized access to instances of applications using user credentials and a single application digital certificate that covers all instances of a particular application in a shared computing platform. A single application digital certificate is associated with a particular registered application. The single application digital certificate is used to establish secure communications with as many different instances of the application that are invoked by any number of users of the shared computing platform.

When a user first invokes an instance of a subject application, certain unique user credentials are stored in a mapping facility so as to associate the single application digital certificate with other attributes of an invoked instance of the subject application. The reverse proxy authorization service exposes user application request information (e.g., user credentials, application identifier, etc.) to the mapping facility. The single application digital certificate and certain user-specific information is used to form a communication link for secure access (e.g., using an access token) between a user's context (e.g., browser session or iFrame) and the particular subject application instance that the particular user is authorized to access. In certain embodiments, the application digital certificate comprises (1) a public key that is stored in a mapping data structure, and (2) a private key that is stored as an environment variable within or accessible to the subject application. In certain embodiments, the user credentials are contained in a user cookie.

### Definitions and Use of Figures

Some of the terms used in this description are defined below for easy reference. The presented terms and their respective definitions are not rigidly restricted to these definitions-a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description of the disclosed embodiments-they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### DESCRIPTIONS OF EXAMPLE EMBODIMENTS

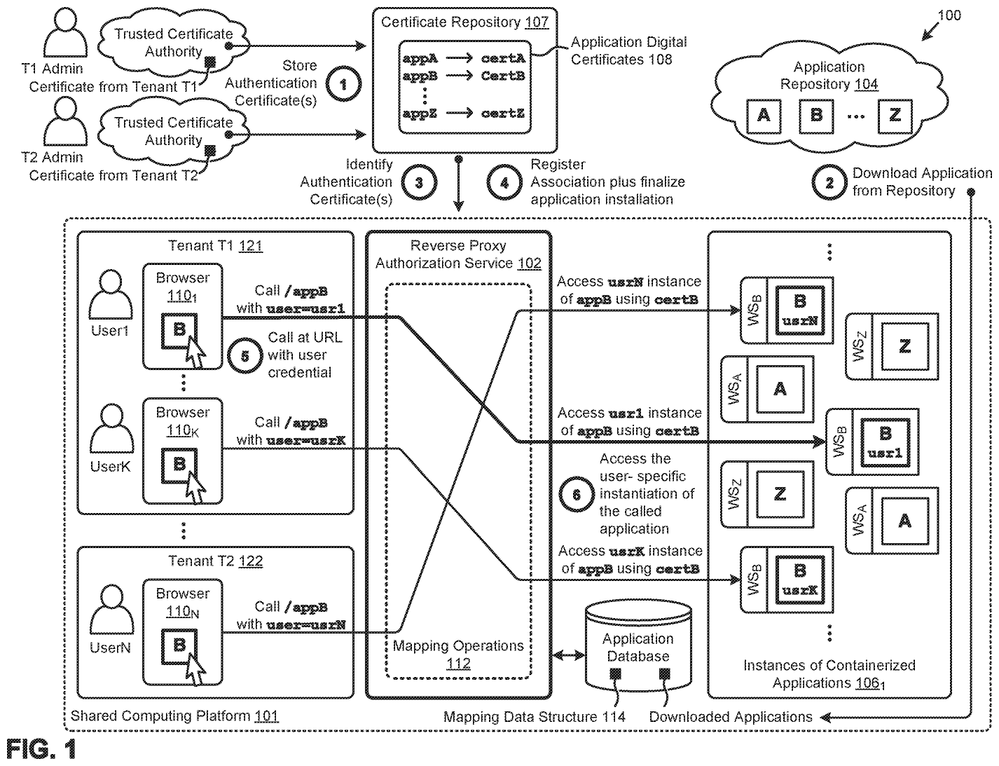

FIG. 1 illustrates a computing environment 100 in which embodiments of the present disclosure can be implemented. As an option, one or more variations of computing environment 100 or any aspect thereof may be implemented in the context of the architecture and functionality of the embodiments described herein.

The embodiment shown in FIG. 1 depicts merely one example of a shared computing platform 101 in an Internet-connected computing environment. Such a shared computing platform is architected to facilitate sharing of resources by multiple entities. In some cases, the multiple entities that have access to the shared resources include entities that access shared resources from outside the shared computing platform (e.g., through a firewall). In other cases, and as shown, the multiple entities that have access to the shared resources include entities that access shared resources from inside the shared computing platform. Such entities, whether situated internally or externally can be a user, or a tenant, or an enterprise, etc.).

In the embodiment shown in FIG. 1, the computing environment 100 comprises a plurality of instances of applications that a set of users (e.g., user1, . . . , userK, . . . , userN) desire to access from a respective browser (e.g., browser 110₁, . . . , browser 110_{K}, . . . , browser 110_{N}). The applications can be any application or web service that can carry out or be subjected to the herein-disclosed authentication and authorization protocol. In some cases, one or more users might be subsumed within a tenant grouping or partition. In the shown example, the partition shown as tenant T1 121 comprises user1 and userK, while the partition shown as tenant T2 122 comprises userN.

At any moment in time, any number of application authentication certificates are received and stored into a certificate repository (operation 1). Often, and as shown, such application authentication certificates are signed by a trusted certificate authority. The application authentication certificates are associated with a particular application that a particular entity desires to run securely within the shared computing platform 101. At some later moment in time, a user that desires to run the application selects it from an application repository 104 (e.g., through browsing actions). The selection of an application from the application repository causes (1) initiation of a download of the selected application (operation 2) to a storage location on the cluster ( ), (2) initiation of a process to identify a previously-provided application-specific digital certificate (e.g., from the certificate repository) and/or to generate an application-specific digital certificate (operation 3) and (3) initiation of a registration process whereby the application is associated with the public key of a corresponding application-specific digital certificate before the application is installed (operation 4).

As pertaining to the foregoing certificate identification or generation process (operation 3), a tenant-provided application digital certificate can be retrieved from the certificate repository. Registration (operation 4) might include entry of the association between the application and the public key of its certificate into a mapping table of an application database. Such a database and table can be accessed whenever an invocation of the application is requested by a user. In most cases, the foregoing download, authentication and registration steps are performed at the time of the first requested use (e.g., by the first requesting user). As such, immediately upon completion of the download, authentication and registration steps, the application is instantiated and made available to be accessed upon request by the requesting user. The steps for instantiating and running the application as a containerized application that is specific to a particular user's context are now briefly discussed.

To be able to instantiate an application that is specific to a particular user's context, the application is encapsulated by code that comprises all or portions of the functions of a web server as well as code that is able to carry out an authentication and authorization protocol at the time of a call to the application by a particular user. Furthermore, a user-specific URL is generated to refer to the user-specific instance of the application. The URL (e.g., IP address and port number) is recorded in the application database. Once the user-specific URL for the application has been registered into the application database, access to the application is made available for invocation (e.g., via a web page application list, or a pull-down menu, or such as from a link within an iFrame, etc.). An invocation of an application such as is depicted by the user's call (operation 5) will be routed to the URL that corresponds to the user-specific instance of the application that has been registered into the application database (operation 6). The encapsulating code can take many forms, one of which form is discussed hereunder as pertains to techniques for containerizing applications.

In the embodiment of FIG. 1, the applications are instances of containerized applications 1061 that can be instantiated (e.g., downloaded, registered, installed, etc.) from an application repository 104 comprising multiple applications (e.g., application “A”, application “B”, . . . , application “Z”). In some cases, the applications in application repository 104 comprise containerized images that are instantiated at installation. The installed containerized applications comprise all or portions of the functions of a web server (e.g., WS_{A}, WS_{B}, . . . , WS_{Z}) as well as functions to facilitate secure access to the containerized application instance as a web service or as a microservice. Specifically, and as shown, each containerized application instance is configured to carry out an authentication and authorization protocol with the reverse proxy authorization service.

As earlier indicated, multiple instances of a particular containerized application can be present in computing environment 100. Specifically, for example, multiple instances of application “B” might be invoked by the foregoing users. More specifically, an application “B” instance invoked by user1 (e.g., identified by “usr1”), an application “B” instance invoked by userK (e.g., identified by “usrK”), and an application “B” instance invoked by userN (e.g., identified by “usrN”) are shown in the instances of containerized applications 1061. Multiple instances of application “A” and application “Z” are also shown.

Efficiently managing secure access to the aforementioned multiple user-specific instances of applications can present challenges. The herein disclosed techniques address such challenges by implementing a reverse proxy authorization service 102 to facilitate authorized access to instances of containerized applications 1061 using user credentials (e.g., “user=user1”) and a single application digital certificate that is common to all instances of a containerized application.

As illustrated in a representative set of application digital certificates 108, a single application digital certificate is generated for each particular containerized application. Specifically, one application digital certificate identified as “certA” is generated for application “A” or “appA”. The certificate “certA” will be used to securely access any and all instances of “appA”. As further shown, “certB” is generated for “appB”, and “certZ” is generated for “appZ”. The application digital certificates can be generated, for example, responsive to an installation of the first instance of a particular containerized application. Individual certificates of the set of application digital certificates may comprise a “Subject” field and a “Public Key” field, as shown. The “Subject” field can be populated with an identifier of the application, or the “Subject” field can be populated with the unique identifier (UUID) of the container that encapsulates the application. In some cases, the certificate repository 107 (e.g., a folder or file or database object, etc.) might be populated with a certificate that is provided by an entity such as a tenant of the shared computing platform 101, or an owner/operator of the shared computing system, or an application developer, etc. Such an entity might cause an administrator to engage with a trusted certificate authority so as to have a signed certificate to be referred to in the application. If a tenant or other entity does not provide a certificate, a certificate can be generated by the reverse proxy authorization service 102 or other certificate generation agent. Certificates that are generated in absence of an entity-provided certificate are referred to herein as self-signed certificates.

When a user first identifies a particular application (e.g., for download and use), certain credentials that are unique to the user are associated with the application digital certificate of the application. Such an association, plus additional other attributes of the user and/or the particular instance of the containerized application are stored in a mapping data structure 114. The reverse proxy authorization service 102 exposes user application request information (e.g., user credentials, application identifier, etc.) to the mapping data structure 114 to facilitate various operations, such as lookup and mapping operations 112. Specifically, mapping operations 112 serve, for example, to identify and securely connect a particular web browser session to the particular containerized application instance that a particular user is authorized to access.

As an example use of an application as a web service, user1 might issue a call (e.g., HTTP GET) to “/appB” that includes certain user credentials, such as “user=usr1” and/or other characteristics that can be derived from user data such as from a cookie. The reverse proxy authorization service 102 consults an application database to access the data stored in the mapping data structure 114 so as to identify details pertaining to a particular authorized instance of “appB” that user1 can access. Details in the mapping data structure might comprise the location information (e.g., IP address, port, etc.) of the web server of the authorized instance. Reverse proxy authorization service 102 can then access the authorized instance (e.g., “usr1” instance) using the application digital certificate “certB”, thereby establishing a secure (e.g., authenticated and authorized) connection between the authorized instance of browser 110₁ and the authenticated instance of application “B”. In some cases, the “Subject” field of the digital certificate is populated with a unique identifier of the encapsulating container rather than the identifier of the underlying application. Validation in such cases comprises comparing the unique identifier of the encapsulating container as given in the certificate to the unique identifier of the encapsulating container as given in the mapping data structure. Other cases illustrating the mapping of requests for “appB” from userK and userN using the herein disclosed techniques are discussed infra.

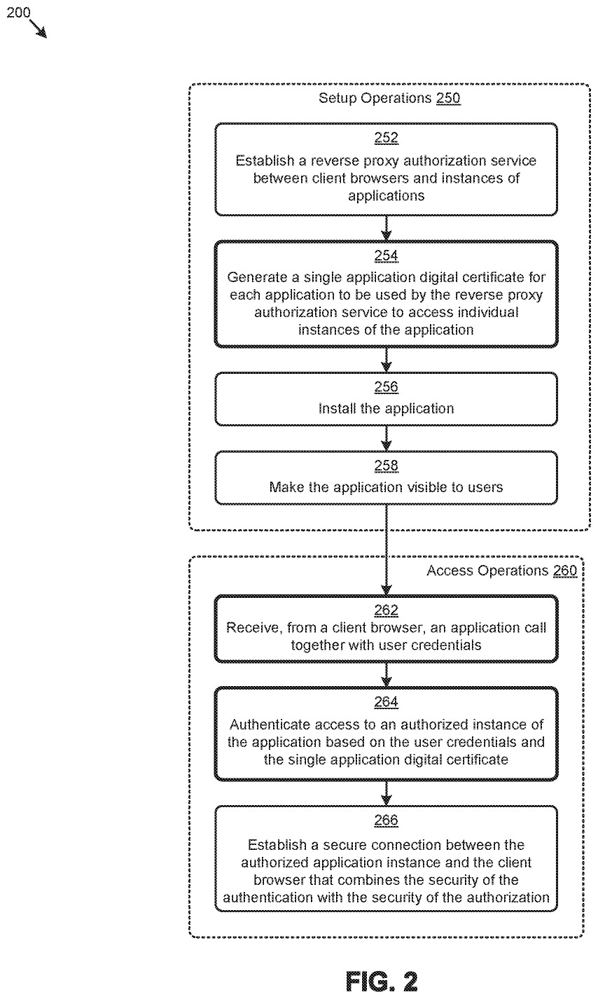

FIG. 2 depicts a secure application access technique 200 as implemented in systems that facilitate authorized user access to instances of authenticated applications. As an option, one or more variations of secure application access technique 200 or any aspect thereof may be implemented in the context of the architecture and functionality of the embodiments described herein. The secure application access technique 200 or any aspect thereof may be implemented in any environment.

The secure application access technique 200 presents one embodiment of certain steps and/or operations that facilitate authorized user access to instances of authenticated applications. As illustrated, the secure application access technique 200 can comprise a set of setup operations 250 and a set of access operations 260. Specifically, the setup operation might commence by establishing a reverse proxy authorization service between various client browsers and instances of applications (step 252). A single application digital certificate for each particular containerized application is generated for use by the reverse proxy authorization service with all instances of the containerized application (step 254). The set of setup operations 250 continues by installing the application (step 256) into the shared computing platform 101, and making the application visible to users (step 258).

The access operations 260 can commence upon receiving, from one of the client browsers, an application call that includes user credentials (step 262). An authorized instance from the instances of the application is then securely accessed based on the user credentials from the request and the single application digital certificate that had been associated with the called application (step 264). A secure connection between the authorized application instance and the client browser is then established (step 266).

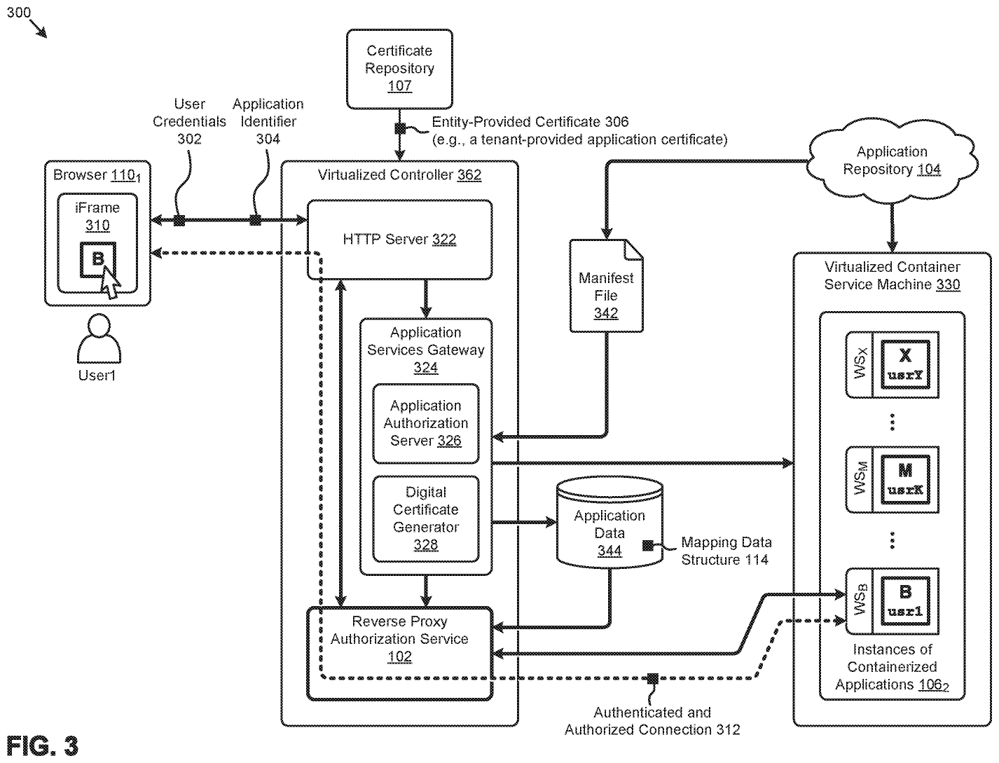

One embodiment of system components and data flows for implementing the herein disclosed techniques is shown and described as pertaining to FIG. 3.

FIG. 3 presents a data flow 300 that implements authorized user access to instances of authenticated containerized applications. As an option, one or more variations of data flow 300 or any aspect thereof may be implemented in the context of the architecture and functionality of the embodiments described herein. The data flow 300 or any aspect thereof may be implemented in any environment.

The shown data flow 300 presents various representative interactions between a set of system components. The interactions are illustrative of the herein disclosed techniques for facilitating authorized user access to instances of authenticated containerized applications. In the specific embodiment shown, a user (e.g., user1) at browser 110₁ interacts with a virtualized controller 362 comprising an HTTP server 322, an application services gateway 324, and an instance of the reverse proxy authorization service 102. The application services gateway 324 further comprises an application authorization server 326 and a digital certificate generator 328. Further shown in FIG. 3 are a set of instances of containerized applications 1062 managed at a virtualized container service machine 330. The virtualized container service machine 330 manages various operations pertaining to the containerized applications (CAs), such as download of the CA (e.g., from application repository 104), installation or instantiation of the CA, starting the CA, stopping the CA, deleting the CA, and/or other operations. As shown, each representative CA instance (e.g., application “X” associated with user “usrY”, . . . , application “M” associated with user “usrK”, . . . , application “B” associated with user “usr1”) includes a respective web server (e.g., WS_{X}, . . . , WS_{M}, . . . , WS_{B}, respectively) to facilitate accessing the CA instance.

Further details regarding general approaches for making and using virtualized container service machines are described in U.S. Patent Application Publication No. 2016/0359955 titled, “ARCHITECTURE FOR MANAGING I/O AND STORAGE FOR A VIRTUALIZATION ENVIRONMENT USING EXECUTABLE CONTAINERS AND VIRTUAL MACHINES” published on Dec. 8, 2016, which is hereby incorporated by reference in its entirety.

Such access might be invoked by user1 interacting with an iFrame 310 associated with application “B” that is rendered by HTTP server 322 in browser 110₁. For example, clicking on the “B” icon in iFrame 310 might launch a call for application “B” that is received by HTTP server 322. Such a call might include a set of user credentials 302 and/or an application identifier 304. The HTTP server 322 can authenticate user1 (e.g., using the user credentials 302), and then redirect the request (e.g., based on the application identifier 304). For example, if the request pertains to an application that is not yet installed, the application authorization server 326 (e.g., an OAuth2.0 server) can be invoked to authenticate and register the application.

In some cases, application authorization server 326 can access a manifest file 342 comprising various attributes (e.g., application identifier, authentication credentials, etc.) to facilitate such operations. The application authorization server 326 can further issue instructions to the virtualized container service machine 330 to download and/or install the requested application. When an application request pertains to an application that is registered but has no instance authorized for access by the requester, application authorization server 326 can issue instructions to the virtualized container service machine 330 to instantiate the requested application.

In accordance with the herein disclosed techniques, an application digital certificate (e.g., a self-signed certificate) is generated for each application. In some situations, a tenant or owner seeks to provide a higher degree of security than is associated with a certificate that is generated on the shared computing platform. In such cases, the tenant may use a trusted certificate authority to obtain a certificate for an application. As shown, a first entity (e.g., tenant T1) secures its tenant-specific certificate using a first trusted certificate authority, and a second entity (e.g., tenant T2) secures a different tenant-specific certificate using a second trusted certificate authority. Such certificates can be provided at any moment in time, and can be stored in the certificate repository 107 at any moment in time. Any component of the virtualized controller 362, including the reverse proxy authorization service 102 can access the certificate repository 107 to retrieve an entity-provided certificate 306 (e.g., a tenant-provided application certificate). The public key and other identifying information of the entity-provided certificate 306 is stored in the mapping data structure 114 to reflect its association with the application that is authenticatable using the entity-provided certificate 306.

However, if no entity-provided certificate 306 is provided, or if for any reason a certificate has not yet been generated for a particular requested application, digital certificate generator 328 can generate the single certificate for the particular requested application. As such, the application digital certificate can be a self-signed certificate signed by the owner of, for example, the resources comprising the virtualized controller 362 and the virtualized container service machine 330. A public key and private key associated with the application digital certificate might also be created. Such keys, for example, can be used to authenticate the application digital certificate with respect to its corresponding authenticatable application.

Certain information from the generated application digital certificates and/or from the installed or instantiated containerized applications can be stored in a set of application data 344. Specifically, a set of instance attributes for each containerized application instance are associated in a mapping data structure 114 stored in application data 344. The reverse proxy authorization service 102 exposes user application request information (e.g., user credentials 302, application identifier 304, etc.) to the mapping data structure 114 to identify and securely connect a requesting user to the particular containerized application instance that the user is authorized to access. As can be observed in the example of FIG. 3, the herein disclosed techniques can facilitate establishment of an authenticated and authorized connection 312 between browser 110₁ and application “B” associated with user “usr1” from the instances of containerized applications 1062.

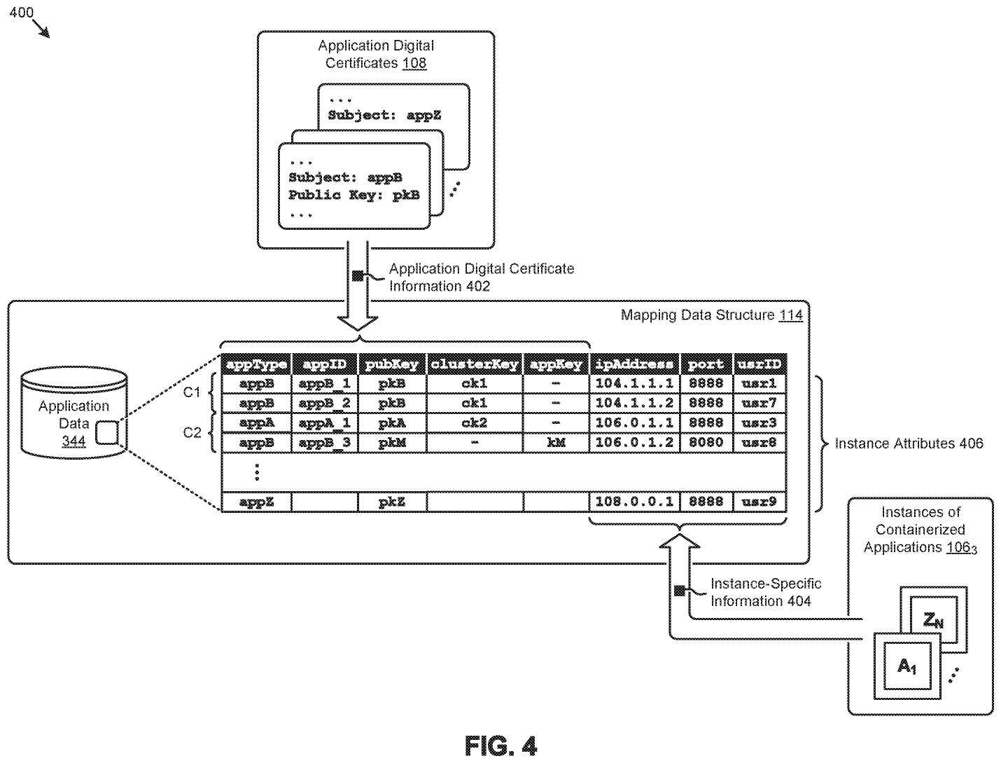

The components and data flows shown in FIG. 3 present merely one partitioning and associated data manipulation approach. The specific example shown is purely exemplary, and other subsystems and/or partitioning are reasonable. Various embodiments of specialized data structures (e.g., mapping data structure 114) that are designed to improve the way a computer stores and retrieves data in memory when implementing the herein disclosed techniques are also possible. One such embodiment of certain specialized data structures is shown and described as pertains to FIG. 4.

FIG. 4 is a diagrammatic representation of data structures 400 used in systems for authorized user access to instances of authenticated containerized applications. As an option, one or more variations of data structures 400 or any aspect thereof may be implemented in the context of the architecture and functionality of the embodiments described herein. The data structures 400 or any aspect thereof may be implemented in any environment.

The mapping data structure 114 shown in FIG. 4 is merely one example of a specialized data structure designed to improve the way a computer stores and retrieves data in memory when implementing systems that facilitate authorized user access to instances of authenticated containerized applications. Any data structure of any organization or construction that relates (e.g., associates, maps, etc.) a set of instance attributes 406 corresponding to specific instances of containerized applications can be in the process of carrying-out the herein disclosed techniques.

As can be observed, such a data structure (e.g., mapping data structure 114) might organize and/or store (e.g., in application data 344) instance attributes and/or other data in a tabular structure (e.g., relational database table). Such tabular structures might have rows corresponding to a particular containerized application instance and columns corresponding to various attributes pertaining to that instance. Specifically, as illustrated in FIG. 4, the rows of a tabular embodiment of mapping data structure 114 can comprise application digital certificate information 402 from the application digital certificates 108. The rows of mapping data structure 114 can also comprise instance-specific information 404 corresponding to the instances of containerized applications 1063.

More specifically, for example, each table row might describe a unique combination of a containerized application instance. Strictly as one example, a table row might comprise an entry that characterizes an application type or name (e.g., appB, or SQL_Server, etc.) such as is shown in the column labeled “appType”. Further, each row might also comprise an application instance identification information such as an “appID” (e.g., appB_1, appB_2, etc.) of the underlying containerized application. Still further each row might include, a public key or “pubKey” from the application digital certificate of the containerized application. In some cases, a row will hold more than one key, where the additional columns of a row hold respective keys from multiple certificates. Still further, each row might also comprise an “ipAddress” and “port” of the instance, a user identifier or “usr D” of the user or users authorized to access the instance, and/or other attributes that uniquely describe a particular instance of the containerized application. In some cases, such as is found in a multi-cluster computing environment, a cluster ID (e.g., “C1”, “C2”, etc.) might be used to associate any application instances on a respective cluster. Such a cluster ID can be coded into a row of the mapping data structure 114, or can be stored in any other location accessible to the shared computing platform.

As earlier described, mapping data structure 114 can be used in accordance with the herein disclosed techniques to identify and securely connect to a particular containerized application instance that a particular user is authorized to access. For example, if a user identified as “usr3” requests access to an application identified as “appA”, mapping data structure 114 can be analyzed to determine that “usr3” is authorized to access an instance “appA 1” of an application of application type “appA” and is instantiated on port “8888” in a processing environment (e.g., a node of cluster “C2”) having an IP address of “106.0.1.1”. In this case, the public key “pkA” (and associated application digital certificate) can be used to establish secure access to the web server of the authorized instance at URL “http://106.0.1.1:8888”.

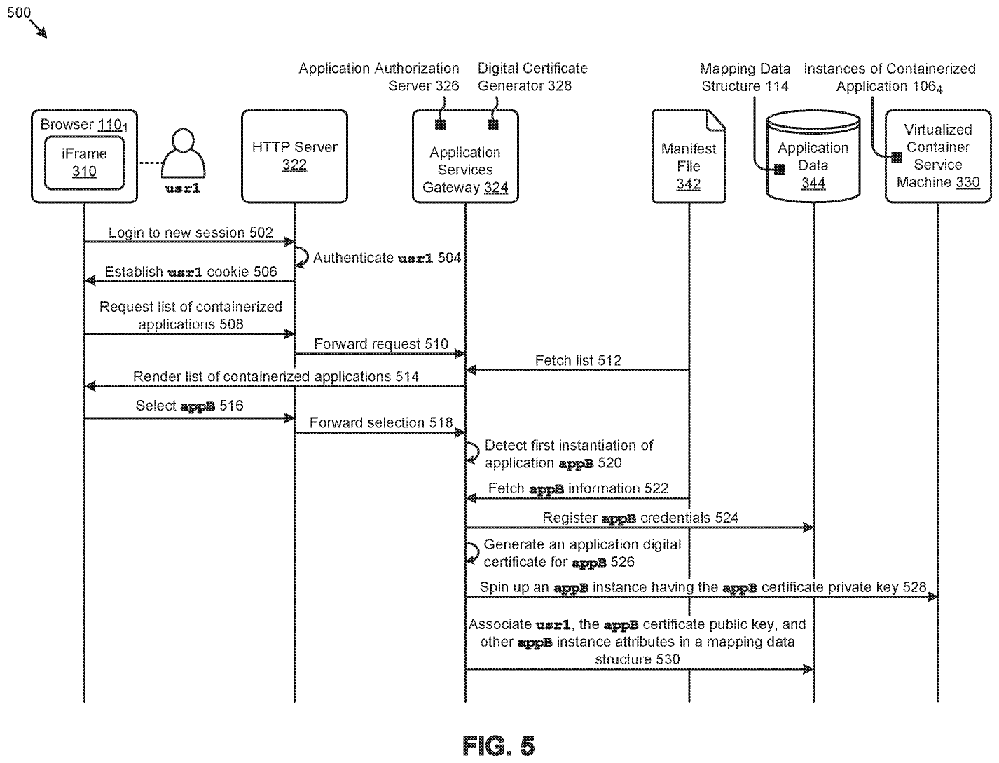

Further details related to the implementation and use of specialized data structures such as mapping data structure when carrying out the herein disclosed techniques are shown and discussed as pertains to FIG. 5.

FIG. 5 is a diagrammatic representation of component-to-component interactions 500 that initialize authorized user access to instances of authenticated applications. As an option, one or more variations of component-to-component interactions 500 or any aspect thereof may be implemented in the context of the architecture and functionality of the embodiments described herein. The component-to-component interactions 500 or any aspect thereof may be implemented in any environment.

Component-to-component interactions 500 presents various system components earlier described (e.g., in FIG. 3) that can exhibit a set of high order interactions (e.g., operations, messages, etc.) to facilitate the herein disclosed techniques. Specifically shown are browser 110₁ comprising iFrame 310 that is accessed by user “usr1”, an HTTP server 322, an application services gateway 324 (comprising application authorization server 326 and digital certificate generator 328), a manifest file 342, application data 344 (comprising mapping data structure 114), and a virtualized container service machine 330 that in turn comprises instances of containerized applications 1064.

As can be observed, when user “usr1” logs in to a new session (message 502), HTTP server 322 authenticates “usr1” (operation 504) and establishes a “usr1” cookie (message 506). User “usr1” might then request a list of available applications to explore at browser 110₁ (message 508). The request, received at HTTP server 322 is forwarded to application services gateway 324 (message 510). The list of applications is fetched from manifest file 342 (message 512) and rendered to browser 110₁ (e.g., in iFrame 310) (message 514).

Further details regarding general approaches for making and using manifest files are described in U.S. patent application Ser. No. 15/665,079 titled “APPLICATION CONFIGURATION IN DISTRIBUTED SYSTEMS USING A MANIFEST FILE”, filed on Jul. 31, 2017, which is hereby incorporated by reference in its entirety.

Continuing the discussion of FIG. 5, the user “usr1” might then select an application, such as application “B”, which is uniquely identified by “appB” (message 516). The selection, received at HTTP server 322 is forwarded to application services gateway 324 (message 518). In the example interactions shown in FIG. 5, the application services gateway 324 detects the received selection, which constitutes a first instantiation of application “appB” (operation 520). As such, certain information associated with application “appB” is fetched from the manifest file 342 (message 522). User credentials (e.g., client ID and client secret) that are used to authenticate the application (e.g., at application authorization server 326) might be retrieved from the user, or from any location where such credentials are securely stored. Other attributes might also be retrieved to facilitate download, containerization, installation, and/or other operations pertaining to the application. The aforementioned credentials and/or other information are stored in application data 344 as part of a registration process (message 524).

In some cases, the first instantiation of an application (e.g., “appB”) invokes the generation of an application digital certificate (operation 526). For example, digital certificate generator 328 might generate a self-signed certificate and corresponding public and private keys for “appB” to be used with all instances of “appB”. Application services gateway 324 can then instruct the virtualized container service machine 330 to spin up an “appB” instance having the private key for authenticating the application digital certificate of “appB” (message 528). In some cases, the private key can be stored in the environment variables of the new “appB” instance. In other cases, the private key can be stored in a secure mapping facility, such as is depicted by the “appKey” column entry “kM” pertaining to the entry for user “user8”. The private key might also be stored in a secure set of storage resources accessible by the new “appB” instance. The public key for the application digital certificate can be stored in the certificate document and/or in a secure mapping facility, and/or in any other repository. As earlier discussed, the public key is also associated with user “usr1” requesting the new “appB” instance together with other “appB” attributes (e.g., IP address, port, etc.) in mapping data structure 114 stored in application data 344 (message 530).

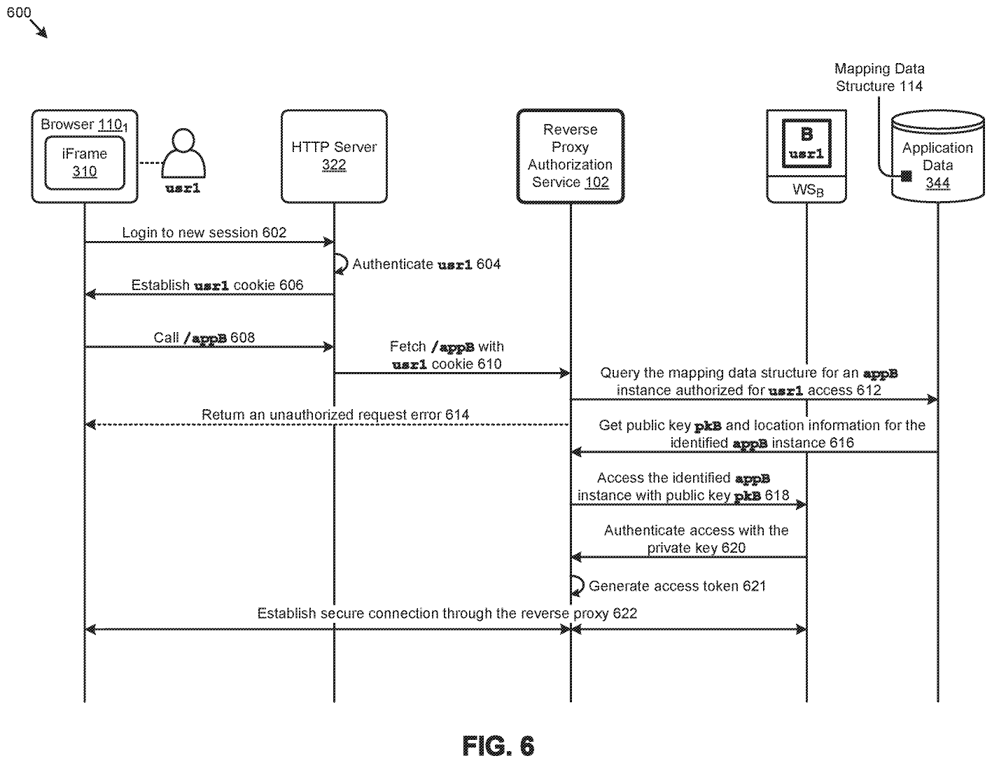

The application data for the new “appB” instance and the other instances of containerized applications 1064 is used by a reverse proxy authorization service according to the herein disclosed techniques to establish secure connections between containerized application instances and the browsers of users authorized to access the instances. One technique for establishing such connections is shown and described as pertains to FIG. 6.

FIG. 6 is an interaction diagram 600 showing component-to-component interactions that facilitate authorized user access to instances of authenticated applications. As an option, one or more variations of interaction diagram 600 or any aspect thereof may be implemented in the context of the architecture and functionality of the embodiments described herein. The interaction diagram 600 or any aspect thereof may be implemented in any environment.

Interaction diagram 600 presents various system components earlier described (e.g., in FIG. 3) that can exhibit a set of high order interactions (e.g., operations, messages, etc.) to facilitate the herein disclosed techniques. Specifically shown are browser 110₁ comprising iFrame 310 that is accessed by user “usr1”, the HTTP server 322, the reverse proxy authorization service 102, and a web server WS_{B}, that is configured with a representative application “B” instance that is associated with user “usr1”. The interaction diagram further shows application data 344 comprising the mapping data structure 114.

As can be observed, when user “usr1” logs in to a new session (message 602), HTTP server 322 authenticates “usr1” (operation 604) and establishes a “usr1” cookie (message 606). User “usr1” might then call an application “B” that is uniquely identified as “appB” (message 608). Upon receiving the call, HTTP server 322 issues a request for “appB” with the “usr1” cookie to the reverse proxy authorization service 102 (message 610). The reverse proxy authorization service 102 queries the mapping data structure 114 at application data 344 to identify an “appB” instance that “usr1” is authorized to access (message 612). If no authorized instance is found, an unauthorized request error is returned (message 614). If an authorized instance is discovered, the public key (e.g., “pkB”), the location information (e.g., IP address, port, etc.), and/or other information associated with the authorized “appB” instance is retrieved from the application data 344 (message 616).

The public key “pkB” and the corresponding application digital certificate earlier generated according to the herein disclosed techniques are used to initiate access with the identified authorized instance of “appB” (message 618). The private key held by the authorized instance is used to authenticate the certificate and/or requested access (message 620). In some situations, and as shown, the proxy authorization service generates an access token (operation 621), which is in turn used to establish a secure connection (message 622) between browser 110₁ and the authorized instance of “appB” through reverse proxy authorization service 102. The access token can be generated to pertain to any level of granularity or scope, using any combination of entity identifiers. For example, an access token can be generated to be associated with permissions that pertain only to a single, specific user, or an access token can be associated with permissions that pertain more broadly to a particular tenant (e.g., so that tenant T1 cannot ‘sniff’ the network for tenant T2's token and then misappropriate the sniffed-out token to access tenant T2's resources), or an access token can be associated with permissions that apply to a cluster-wide scope. As other examples, the access scope of a token can limit to the user level, or to the application level, or to the tenant level, or to the cluster level, or any combination thereof.

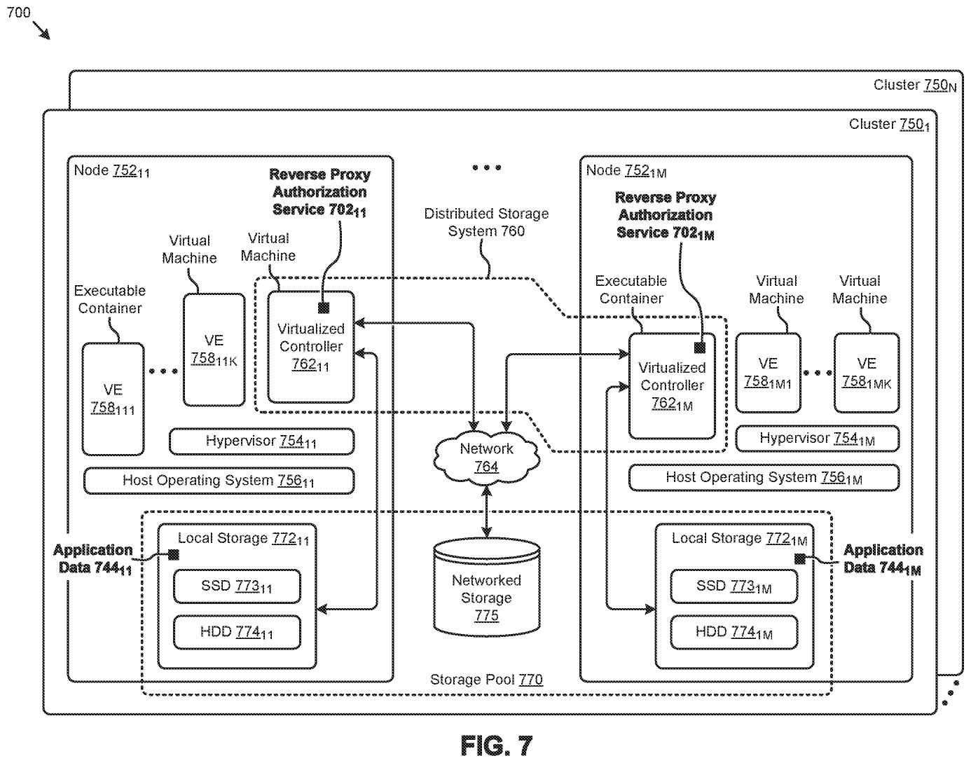

An example of a distributed virtualization environment (e.g., distributed computing environment, hyperconverged distributed computing environment, etc.) that supports any of the herein disclosed techniques is presented and discussed as pertains to FIG. 7.

FIG. 7 presents a distributed virtualization environment 700 in which embodiments of the present disclosure can be implemented. As an option, one or more variations of distributed virtualization environment 700 or any aspect thereof may be implemented in the context of the architecture and functionality of the embodiments described herein. The distributed virtualization environment 700 or any aspect thereof may be implemented in any environment.

The shown distributed virtualization environment depicts various components associated with one instance of a distributed virtualization system (e.g., hyperconverged distributed system) comprising a distributed storage system 760 that can be used to implement the herein disclosed techniques. Specifically, the distributed virtualization environment 700 comprises multiple clusters (e.g., cluster 750₁, . . . , cluster 750_{N}) comprising multiple nodes that have multiple tiers of storage in a storage pool. Representative nodes (e.g., node 752₁₁, . . . , node 752_{1M}) and storage pool 770 associated with cluster 750₁ are shown. Each node can be associated with one server, multiple servers, or portions of a server. The nodes can be associated (e.g., logically and/or physically) with the clusters. As shown, the multiple tiers of storage include storage that is accessible through a network 764, such as a networked storage 775 (e.g., a storage area network or SAN, network attached storage or NAS, etc.). The multiple tiers of storage further include instances of local storage (e.g., local storage 772₁₁, . . . , local storage 772_{1M}). For example, the local storage can be within or directly attached to a server and/or appliance associated with the nodes. Such local storage can include solid state drives (SSD 773₁₁, . . . , SSD 773_{1M}), hard disk drives (HDD 774₁₁, . . . , HDD 774_{1M}), and/or other storage devices.

As shown, the nodes in distributed virtualization environment 700 can implement one or more user virtualized entities (e.g., VE 758₁₁₁, . . . , VE 758_{11K}, . . . , VE 758_{1M1}, . . . , VE 758_{1MK}), such as virtual machines (VMs) and/or containers. The VMs can be characterized as software-based computing “machines” implemented in a hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 756₁₁, . . . , host operating system 756_{1M}), while the VMs run multiple applications on various respective guest operating systems. Such flexibility can be facilitated at least in part by a hypervisor (e.g., hypervisor 754₁₁, . . . , hypervisor 754_{1M}), which hypervisor is logically located between the various guest operating systems of the VMs and the host operating system of the physical infrastructure (e.g., node).

As an example, hypervisors can be implemented using virtualization software (e.g., VMware ESXi, Microsoft Hyper-V, RedHat KVM, Nutanix AHV, etc.) that includes a hypervisor. In comparison, the containers (e.g., application containers or ACs) are implemented at the nodes in an operating system virtualization environment or container virtualization environment. The containers comprise groups of processes and/or resources (e.g., memory, CPU, disk, etc.) that are isolated from the node host computer and other containers. Such containers directly interface with the kernel of the host operating system (e.g., host operating system 756₁₁, . . . , host operating system 756_{1M}) without, in most cases, a hypervisor layer. This lightweight implementation can facilitate efficient distribution of certain software components, such as applications or services (e.g., micro-services). As shown, distributed virtualization environment 700 can implement both a hypervisor-assisted virtualization environment and a container virtualization environment for various purposes.

Distributed virtualization environment 700 also comprises at least one instance of a virtualized controller to facilitate access to storage pool 770 by the VMs and/or containers.

As used in these embodiments, a virtualized controller is a collection of software instructions that serve to abstract details of underlying hardware or software components from one or more higher-level processing entities. A virtualized controller can be implemented as a virtual machine, as an executable container (e.g., a Docker container), or within a layer (e.g., such as a layer in a hypervisor).

Multiple instances of such virtualized controllers can coordinate within a cluster to form the distributed storage system 760 which can, among other operations, manage the storage pool 770. This architecture further facilitates efficient scaling of the distributed virtualization system. The foregoing virtualized controllers can be implemented in distributed virtualization environment 700 using various techniques. Specifically, an instance of a virtual machine at a given node can be used as a virtualized controller in a hypervisor-assisted virtualization environment to manage storage and I/O (input/output or IO) activities. In this case, for example, the virtualized entities at node 752₁₁ can interface with a controller virtual machine (e.g., virtualized controller instance 762₁₁) through hypervisor 754₁₁ to access the storage pool 770. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 760.

For example, a hypervisor at one node in the distributed storage system 760 might correspond to VMware ESXi software, and a hypervisor at another node in the distributed storage system 760 might correspond to Nutanix AHV software. As another virtualized controller implementation example, containers (e.g., Docker containers) can be used to implement a virtualized controller (e.g., virtualized controller instance 762_{1M}) in an operating system virtualization environment at a given node. In this case, for example, the virtualized entities at node 752_{1M} can access the storage pool 770 by interfacing with a controller container (e.g., virtualized controller instance 762_{1M}) through hypervisor 754_{1M} and/or the kernel of host operating system 756_{1M}.

In certain embodiments, one or more instances of a reverse proxy authorization service can be implemented in the distributed storage system 760 to facilitate the herein disclosed techniques. Specifically, reverse proxy authorization service 702₁₁ can be implemented in the virtualized controller instance 762₁₁, and reverse proxy authorization service 702_{1M} can be implemented in the virtualized controller instance 762_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents (e.g., a reverse proxy authorization service). Also, one or more instances of certain application data (e.g., comprising one or more instances of a mapping data structure and/or other data structures) can be implemented in the storage pool 770 for access by the distributed storage system 760 to facilitate the herein disclosed techniques. Specifically, as shown, application data instance 74411 can be stored in local storage 772₁₁, and application data instance 744_{1M} can be stored in local storage 772_{1M}.

### Additional Embodiments of the Disclosure

### Additional Practical Application Examples

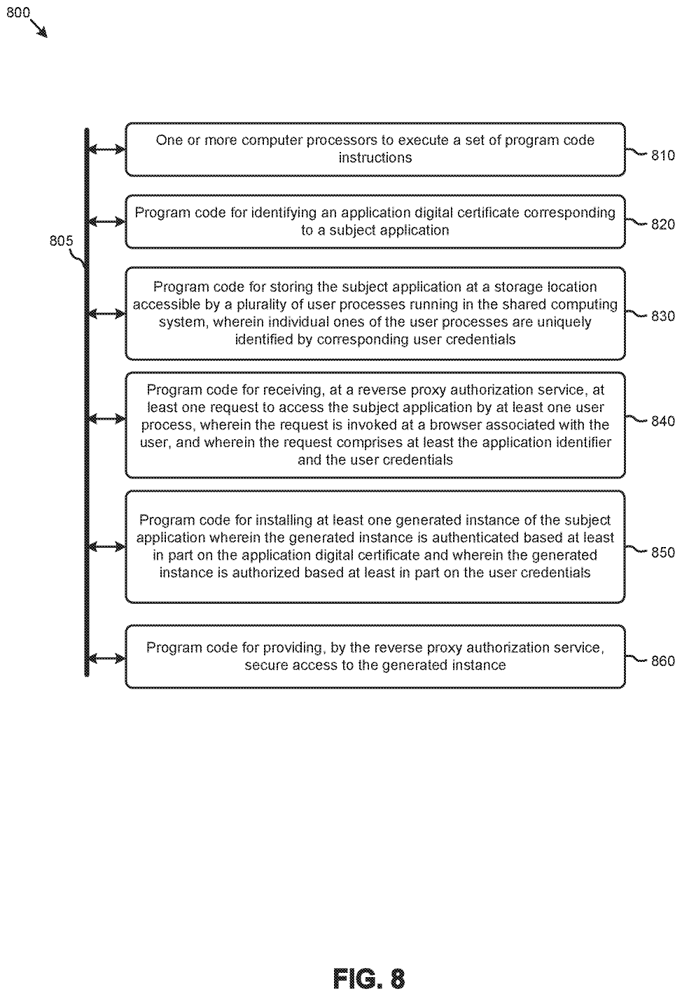

FIG. 8 depicts a system 800 as an arrangement of computing modules that are interconnected so as to operate cooperatively to implement certain of the herein-disclosed embodiments. This and other embodiments present particular arrangements of elements that, individually and/or as combined, serve to form improved technological processes that address efficiently managing secure access to multiple instances of applications. The partitioning of system 800 is merely illustrative and other partitions are possible. As an option, the system 800 may be implemented in the context of the architecture and functionality of the embodiments described herein. Of course, however, the system 800 or any operation therein may be carried out in any desired environment. The system 800 comprises at least one processor and at least one memory, the memory serving to store program instructions corresponding to the operations of the system. As shown, an operation can be implemented in whole or in part using program instructions accessible by a module. The modules are connected to a communication path 805, and any operation can communicate with other operations over communication path 805. The modules of the system can, individually or in combination, perform method operations within system 800. Any operations performed within system 800 may be performed in any order unless as may be specified in the claims. The shown embodiment implements a portion of a computer system, presented as system 800, comprising one or more computer processors to execute a set of program code instructions (module 810) and modules for accessing memory to hold program code instructions to perform: identifying an application digital certificate corresponding to a subject application (module 820); storing the subject application at a storage location accessible by a plurality of user processes running in the shared computing system, wherein individual ones of the user processes are uniquely identified by corresponding user credentials (module 830); receiving, at a reverse proxy authorization service, at least one request to access the subject application by at least one user process, wherein the request is invoked at a browser associated with the user, and wherein the request comprises at least an application identifier and the user credentials (module 840); installing at least one generated instance of the subject application wherein the generated instance is authenticated based at least in part on the application digital certificate and wherein the generated instance is authorized based at least in part on the user credentials (module 850); and providing, by the reverse proxy authorization service, secure access to the generated instance (module 860).

Variations of the foregoing may include more or fewer of the shown modules. Certain variations may perform more or fewer (or different) steps, and/or certain variations may use data elements in more, or in fewer (or different) operations.

### System Architecture Overview

### Additional System Architecture Examples

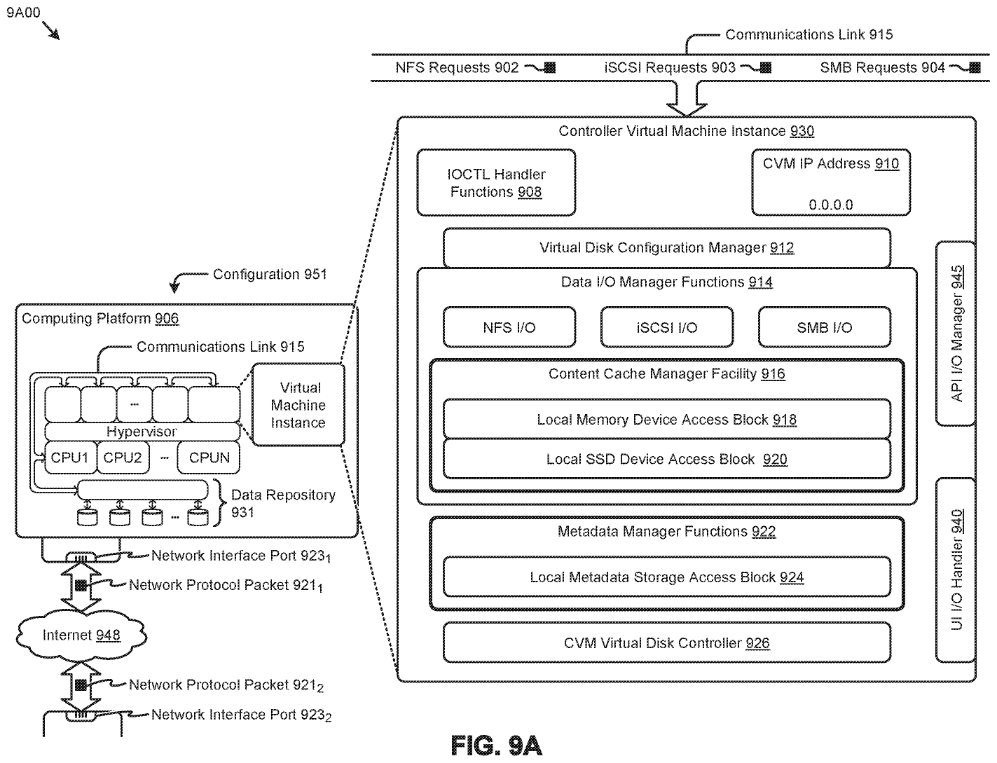

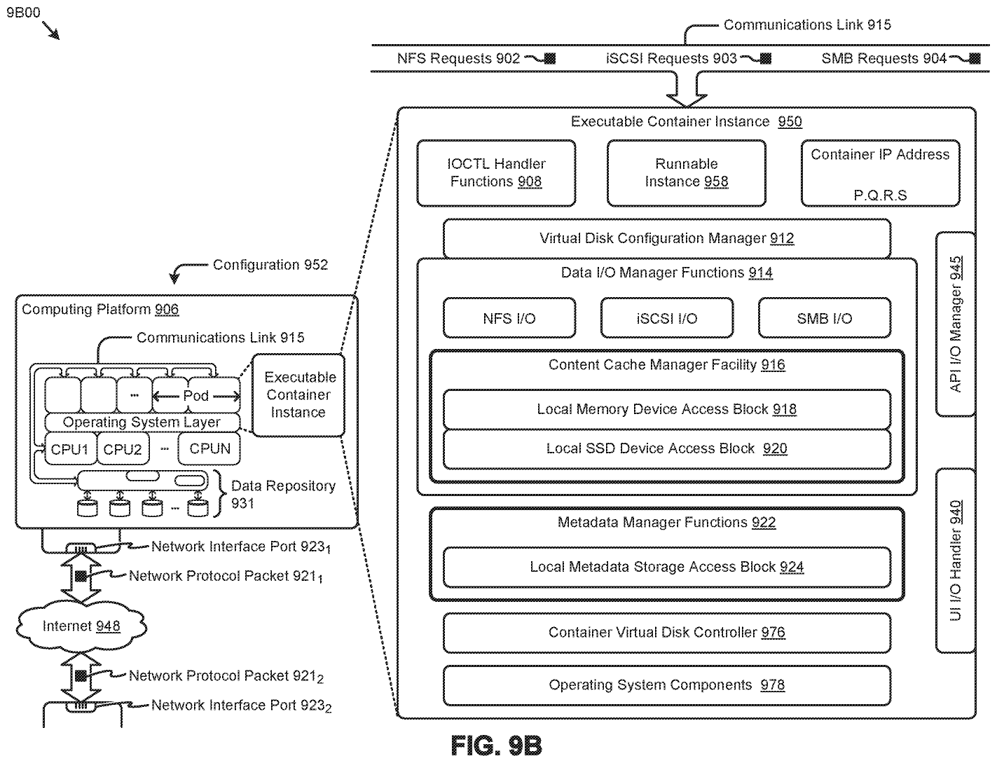

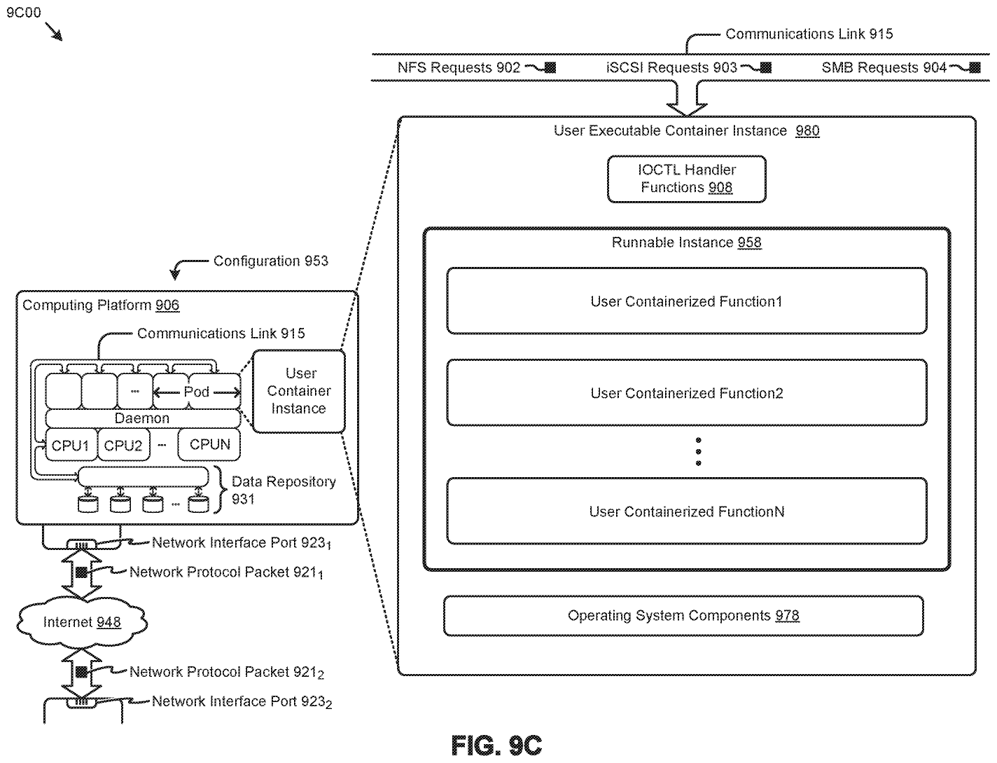

FIG. 9A depicts a virtualized controller as implemented by the shown virtual machine architecture 9A00. The heretofore-disclosed embodiments, including variations of any virtualized controllers, can be implemented in distributed systems where a plurality of networked-connected devices communicate and coordinate actions using inter-component messaging. Distributed systems are systems of interconnected components that are designed for, or dedicated to, storage operations as well as being designed for, or dedicated to, computing and/or networking operations. Interconnected components in a distributed system can operate cooperatively to achieve a particular objective, such as to provide high performance computing, high performance networking capabilities, and/or high performance storage and/or high capacity storage capabilities. For example, a first set of components of a distributed computing system can coordinate to efficiently use a set of computational or compute resources, while a second set of components of the same distributed storage system can coordinate to efficiently use a set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, the virtual machine architecture 9A00 comprises a collection of interconnected components suitable for implementing embodiments of the present disclosure and/or for use in the herein-described environments. Moreover, the shown virtual machine architecture 9A00 includes a virtual machine instance in configuration 951 that is further described as pertaining to controller virtual machine instance 930. Configuration 951 supports virtual machine instances that are deployed as user virtual machines, or controller virtual machines or both. Such virtual machines interface with a hypervisor (as shown). Some virtual machines include processing of storage I/O as received from any or every source within the computing platform. An example implementation of such a virtual machine that processes storage I/O is depicted as 930.

In this and other configurations, a controller virtual machine instance receives block I/O (input/output or IO) storage requests as network file system (NFS) requests in the form of NFS requests 902, and/or internet small computer storage interface (iSCSI) block IO requests in the form of iSCSI requests 903, and/or Samba file system (SMB) requests in the form of SMB requests 904. The controller virtual machine (CVM) instance publishes and responds to an internet protocol (IP) address (e.g., CVM IP address 910). Various forms of input and output (I/O or IO) can be handled by one or more IO control handler functions (e.g., IOCTL handler functions 908) that interface to other functions such as data IO manager functions 914 and/or metadata manager functions 922. As shown, the data IO manager functions can include communication with virtual disk configuration manager 912 and/or can include direct or indirect communication with any of various block IO functions (e.g., NFS IO, iSCSI IO, SMB IO, etc.).

In addition to block IO functions, configuration 951 supports IO of any form (e.g., block IO, streaming IO, packet-based IO, HTTP traffic, etc.) through either or both of a user interface (UI) handler such as UI IO handler 940 and/or through any of a range of application programming interfaces (APIs), possibly through the shown API IO manager 945.

Communications link 915 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as disk drives or tape drives. Volatile media includes dynamic memory such as random access memory. As shown, controller virtual machine instance 930 includes content cache manager facility 916 that accesses storage locations, possibly including local dynamic random access memory (DRAM) (e.g., through the local memory device access block 918) and/or possibly including accesses to local solid state storage (e.g., through local SSD device access block 920).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of external data repository 931, which in turn can be formatted into any one or more storage areas, and which can comprise parameterized storage accessible by a key (e.g., a filename, a table name, a block address, an offset address, etc.). External data repository 931 can store any forms of data, and may comprise a storage area dedicated to storage of metadata pertaining to the stored forms of data. In some cases, metadata can be divided into portions. Such portions and/or cache copies can be stored in the external storage data repository and/or in a local storage area (e.g., in local DRAM areas and/or in local SSD areas). Such local storage can be accessed using functions provided by local metadata storage access block 924. External data repository 931 can be configured using CVM virtual disk controller 926, which can in turn manage any number or any configuration of virtual disks.

Execution of the sequences of instructions to practice certain embodiments of the disclosure are performed by one or more instances of a software instruction processor, or a processing element such as a data processor, or such as a central processing unit (e.g., CPU1, CPU2, . . . , CPUN). According to certain embodiments of the disclosure, two or more instances of configuration 951 can be coupled by communications link 915 (e.g., backplane, LAN, PSTN, wired or wireless network, etc.) and each instance may perform respective portions of sequences of instructions as may be required to practice embodiments of the disclosure.

The shown computing platform 906 is interconnected to the Internet 948 through one or more network interface ports (e.g., network interface port 9231 and network interface port 9232). Configuration 951 can be addressed through one or more network interface ports using an IP address. Any operational element within computing platform 906 can perform sending and receiving operations using any of a range of network protocols, possibly including network protocols that send and receive packets (e.g., network protocol packet 9211 and network protocol packet 9212).

Computing platform 906 may transmit and receive messages that can be composed of configuration data and/or any other forms of data and/or instructions organized into a data structure (e.g., communications packets). In some cases, the data structure includes program code instructions (e.g., application code) communicated through the Internet 948 and/or through any one or more instances of communications link 915. Received program code may be processed and/or executed by a CPU as it is received and/or program code may be stored in any volatile or non-volatile storage for later execution. Program code can be transmitted via an upload (e.g., an upload from an access device over the Internet 948 to computing platform 906). Further, program code and/or the results of executing program code can be delivered to a particular user via a download (e.g., a download from computing platform 906 over the Internet 948 to an access device).

Configuration 951 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to the other units. In some cases, a unit in a rack is dedicated to environmental conditioning functions such as filtering and movement of air through the rack and/or temperature control for the rack. Racks can be combined to form larger clusters. For example, the LAN of a first rack having 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

A module as used herein can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to implement algorithms that facilitate operational and/or performance characteristics pertaining to techniques for authorized user access to instances of authenticated applications. In some embodiments, a module may include one or more state machines and/or combinational logic used to implement or facilitate the operational and/or performance characteristics pertaining to techniques for authorized user access to instances of authenticated applications.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of techniques for authorized user access to instances of authenticated applications). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to techniques for authorized user access to instances of authenticated applications, and/or for improving the way data is manipulated when performing computerized operations pertaining to a reverse proxy authorization service that facilitates authorized access to instances of containerized applications using user credentials and a single digital certificate for all instances of an containerized application.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT”, issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR VIRTUALIZATION ENVIRONMENT”, issued on Oct. 1, 2013, which is hereby incorporated by reference in its entirety.

FIG. 9B depicts a virtualized controller implemented by containerized architecture 9B00. The containerized architecture comprises a collection of interconnected components suitable for implementing embodiments of the present disclosure and/or for use in the herein-described environments. Moreover, the shown containerized architecture 9B00 includes an executable container instance in configuration 952 that is further described as pertaining to the executable container instance 950. Configuration 952 includes an operating system layer (as shown) that performs addressing functions such as providing access to external requestors via an IP address (e.g., “P.Q.R.S”, as shown). Providing access to external requestors can include implementing all or portions of a protocol specification (e.g., “http:”) and possibly handling port-specific functions.

The operating system layer can perform port forwarding to any executable container (e.g., executable container instance 950). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance (e.g., a Docker container instance) can serve as an instance of an application container. Any executable container of any sort can be rooted in a directory system, and can be configured to be accessed by file system commands (e.g., “ls” or “ls-a”, etc.). The executable container might optionally include operating system components 978, however such a separate set of operating system components need not be provided. As an alternative, an executable container can include runnable instance 958, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 976. Such a container virtual disk controller can perform any of the functions that the aforementioned CVM virtual disk controller 926 can perform, yet such a container virtual disk controller does not rely on a hypervisor or any particular operating system so as to perform its range of functions.

In some environments multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 9C depicts a virtualized controller implemented by a daemon-assisted containerized architecture 9C00. The containerized architecture comprises a collection of interconnected components suitable for implementing embodiments of the present disclosure and/or for use in the herein-described environments. Moreover, the shown daemon-assisted containerized architecture includes a user executable container instance in configuration 953 that is further described as pertaining to user executable container instance 980. Configuration 953 includes a daemon layer (as shown) that performs certain functions of an operating system.

User executable container instance 980 comprises any number of user containerized functions (e.g., user containerized function1, user containerized function2, . . . , user containerized functionN). Such user containerized functions can execute autonomously, or can be interfaced with or wrapped in a runnable object to create a runnable instance (e.g., runnable instance 958). In some cases, the shown operating system components 978 comprise portions of an operating system, which portions are interfaced with or included in the runnable instance and/or any user containerized functions. In this daemon-assisted containerized architecture 9C00, computing platform 906 might or might not host operating system components other than operating system components 978. More specifically, the shown daemon might or might not host operating system components other than operating system components 978 of user executable container instance 980.

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

1. A method, comprising:
receiving a digital certificate that is generated for an application, wherein different digital certificates are generated for different applications;
receiving multiple requests to access the application from multiple users; and
servicing the multiple requests from the multiple users at least by authorizing the multiple users to access respective instances of the application based at least in part upon separate user credentials of the multiple users and the digital certificate, wherein the digital certificate is common to the respective instances of the application.

2. The method of claim 1, wherein the digital certificate that corresponds to the application is a tenant-provided application digital certificate that is common to the multiple users.

3. The method of claim 1, further comprising storing a copy of the application at a storage location accessible by multiple user processes running in a shared computing system.

4. The method of claim 1, further comprising authenticating the respective instances of the application using the same digital certificate.

5. The method of claim 1, further comprising mapping, by a reverse proxy authorization service, the respective instances to the multiple requests from the multiple users, wherein mapping the respective instances to the multiple requests comprises accessing a mapping data structure that comprises an instance attribute of the application.

6. The method of claim 5, wherein the instance attribute comprises an application identifier, the separate user credentials, a public key, an IP address, or a port.

7. The method of claim 6, further comprising querying a mapping data structure to identify a particular instance of the application that corresponds to a combination of an application identifier of the application and a user credential of the separate user credentials.

8. The method of claim 1, further comprising creating, by a controller virtual machine, a self-signed certificate as the digital certificate, the self-signed certificate having a public key and a private key.

9-14. (canceled)

15. A non-transitory computer readable medium having stored thereon a sequence of instructions which, when stored in memory and executed by a processor, causes the processor to perform a set of acts, the set of acts comprising:
receiving a digital certificate that is generated for an application, wherein different digital certificates are generated for different applications;
receiving multiple requests to access the application from multiple users; and
servicing the multiple requests from the multiple users at least by authorizing the multiple users to access respective instances of the application based at least in part upon separate user credentials of the multiple users and the digital certificate, wherein the digital certificate is common to the respective instances of the application.

16. The non-transitory computer readable medium of claim 15, wherein the same application digital certificate that corresponds to the particular application is a tenant-provided application digital certificate.

17. A system comprising:
a non-transitory storage medium having stored thereon a sequence of instructions; and
a processor executing the sequence of instructions, execution of which causes the to perform a set of acts, the set of acts comprising,
receiving a digital certificate that is generated for an application, wherein different digital certificates are generated for different applications;
receiving multiple requests to access the application from multiple users; and
servicing the multiple requests from the multiple users at least by authorizing the multiple users to access respective instances of the application based at least in part upon separate user credentials of the multiple users and and the digital certificate, wherein the digital certificate is common to the respective instances of the application.

18. The system of claim 17, wherein the digital certificate that corresponds to the application is a provided by a tenant that comprises a user of the multiple users.

19. The system of claim 17, further comprising instructions to cause the processor to store a copy of the particular application at a storage location accessible by a plurality of user processes running in the shared computing system.

20. The system of claim 17, the non-transitory storage medium further comprising instructions which, when executed by the processor, cause the processor to authenticate both the respective instances of the application using the digital certificate.

21. A non-transitory computer readable medium having stored thereon a sequence of instructions which, when stored in memory and executed by a processor, causes the processor to perform a set of acts, the set of acts comprising:
receiving a digital certificate that is generated for an application, wherein different digital certificates are generated for different applications;
receiving multiple requests to access the application from multiple users;
servicing the multiple requests from the multiple users at least by authenticating installation of respective instances of the application for the multiple users using separate user credentials of the multiple users the digital certificate, wherein the digital certificate is common to the respective instances of the application; and
storing, in a mapping data structure, respective instance attributes that correspond the digital certificate to the respective user credentials.

22. A non-transitory computer readable medium having stored thereon a sequence of instructions which, when stored in memory and executed by a processor, causes the processor to perform a set of acts, the set of acts comprising:
receiving a digital certificate that is generated for an application, wherein different digital certificates are generated for different applications;
receiving multiple requests to access respective instances of the application from multiple users, the respective instances of the application had been authenticated using at least the digital certificate that is common to the multiple users; and
generating, by a reverse proxy authorization service, respective access tokens corresponding to the multiple requests.

23. The non-transitory computer readable medium of claim 15, the sequence of instructions, when stored in the memory and executed by the processor, further causing the processor to perform the set of acts that further comprises generating, by a controller virtual machine, the digital certificate that is self-signed.

24. The non-transitory computer readable medium of claim 15, wherein the digital certificate is provided by a user of the multiple users and is common to the multiple users.

25. The non-transitory computer readable medium of claim 21, the sequence of instructions, when stored in the memory and executed by the processor, further causing the processor to perform the set of acts that further comprises forming a secure communication link between a computing context of a tenant and a corresponding instance of the respective instances by using at least the digital certificate, wherein the tenant comprises a user of the multiple users.

26. The non-transitory computer readable medium of claim 21, wherein the digital certificate is provided by a user of the multiple users and is common to the multiple users.

27. The non-transitory computer readable medium of claim 28, the sequence of instructions, when stored in the memory and executed by the processor, further causing the processor to perform the set of acts that further comprises generating, by a controller virtual machine, the digital certificate that is self-signed.

28. The non-transitory computer readable medium of claim 28, the sequence of instructions, when stored in the memory and executed by the processor, further causing the processor to perform the set of acts that further comprises forming a secure communication link between a computing context of a tenant and a corresponding instance of the respective instances by using at least the digital certificate, wherein the tenant comprises a user of the multiple users.
